(19) United States
(12) Patent Application Publication
(10) Pub. No.: US 2011/0205338 A1
(43) Pub. Date: Aug. 25, 2011

(54) Apparatus for estimating position of mobile robot and method thereof

(75) Inventors: Ki-Wan Choi, Anyang-si (KR); Ji-Young Park, Yongin-si (KR); Hyoung-Ki Lee, Seongnam-si (KR)

(73) Assignee: SAMSUNG ELECTRONICS CO., LTD., Suwon-si (KR)

(21) Appl. No.: 12/929,414

(22) Filed: Jan. 21, 2011

(30) Foreign Application Priority Data
Feb. 24, 2010 (KR) 10-2010-0016812

(51) Int. Cl. G06K 9/00; H04N 13/02

(52) U.S. Cl. 348/46; 382/103; 348/E13.074

(57) ABSTRACT

An apparatus and method for estimating the position of a mobile robot capable of reducing the time required to estimate the position is provided. The mobile robot position estimating apparatus includes a range data acquisition unit configured to acquire three-dimensional (3D) point cloud data, a storage unit configured to store a plurality of patches, each including points around a feature point which is extracted from previously acquired 3D point cloud data, and a position estimating unit configured to estimate the position of the mobile robot by tracking the plurality of patches from the acquired 3D point cloud data.

### CROSS-REFERENCE TO RELATED APPLICATIONS

This application claims the benefit under 35 U.S.C. §119(a) of Korean Patent Application No. 10-2010-0016812, filed on Feb. 24, 2010, the disclosure of which is incorporated by reference in its entirety for all purposes.

### BACKGROUND

1. Field

One or more embodiments relate to an apparatus and method for estimating a position of a mobile robot, and particularly, to an apparatus and method for estimating a position of a mobile robot, in which the mobile robot estimates its own position by use of a distance sensor.

2. Description of the Related Art

With the development of new technologies in optics and electronics, more cost effective and accurate laser scanning systems have been implemented. According to a laser scanning system, depth information of an object may be directly obtained, thereby simplifying range image analysis and providing a wide range of applications. The range image is formed of a set of three-dimensional (3D) data points and represents the free surface of an object at different points of view.

In recent years, the registration of a range image has a widely known problem in association with a machine vision. There have been numerous suggested approaches to solve this registration of range image problem, including using a scatter matrix, a geometric histogram, an iterative closest point (ICP), a graph matching, an external point, a range based searching, and an interactive method. Such a registration scheme is applied to various fields such as the object recognition, motion estimation, and scene understanding.

As a representative example of the registration scheme, ICP has garnered a large amount of interest in the machine vision field since its inception. The purpose of ICP is to search a transformation matrix capable of matching a range data set of a range data coordinate system to a model data set in a mathematical manner. Such an ICP scheme offers high accuracy, but requires a large amount of matching time for processing data especially when the amount of data to be processed is intensive, for example, in 3D plane matching.

### SUMMARY

According to one or more embodiments, there is provided an apparatus and method for estimating a position, capable of reducing the amount of data to be computed for position estimation while maintaining the accuracy of the position estimation, thereby reducing the time required for position estimation.

According to one or more embodiments, there is provided an apparatus estimating a position of a mobile robot, the apparatus including a range data acquisition unit configured to acquire three-dimensional (3D) point cloud data, a storage unit configured to store a plurality of patches, each stored patch including points around a feature point which is extracted from previously acquired 3D point cloud data, and a position estimating unit configured to estimate the position of the mobile robot by tracking the plurality of stored patches from the acquired 3D point cloud data.

The apparatus may further include a patch generating unit, configured to extract at least one feature point from the previously acquired 3D point cloud data, generate a patch including the at least one feature point and points around the extracted feature point and store the generated patch in the storage unit as a stored patch.

The patch generating unit may calculate normal vectors with respect to respective points of the previously acquired 3D point cloud data, convert the normal vector to an RGB image by setting 3D spatial coordinates (x, y, z) forming the normal vector to individual RGB values, convert the converted RGB image to a gray image, extract corner points from the gray image by use of a corner extraction algorithm, extract a feature point from the extracted corner points, and generate the patch as including the extracted feature point and points around the extracted feature point.

The patch generating unit may store the generated patch together with position information of the extracted feature point of the generated patch.

The patch generating unit may store points forming the generated patch in the storage unit such that the points forming the patch are stored as divided points of edge points forming an edge and normal points not forming an edge.

The position estimating unit may calculate normal vectors with respect to respective points of the 3D point cloud data, divide the respective points into edge points forming an edge and normal points not forming an edge by use of the normal vectors, and track the stored patch from the 3D point cloud data by use of an edge-based IPC-based algorithm in which the edge point of the stored patch is matched to the edge point of the 3D point cloud data and the normal point of the stored patch is matched to one of the edge point and the normal point of the 3D point cloud data without discriminating between the edge point and the normal point of the 3D point cloud data.

The position estimating unit may match the edge point of the stored patch to a closest edge point of the 3D point cloud data, and matches the normal point of the stored patch to a closest point of the 3D point cloud data.

According to one or more embodiments, there is provided a method of estimating a position of a mobile, the method including acquiring three-dimensional (3D) point cloud data, and estimating the position of the mobile robot by tracking a plurality of stored patches from the acquired 3D point cloud data, the plurality of stored patches each including respective feature points and respective points around each respective feature point extracted from previously acquired 3D point cloud data.

Additional aspects and/or advantages will be set forth in part in the description which follows and, in part, will be apparent from the description, or may be learned by practice of one or more embodiments of the present invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an apparatus for estimating a position of a mobile robot, according to one or more embodiments;

FIG. 2 illustrates a method of estimating a position of a mobile robot, according to one or more embodiments;

FIG. 3 illustrates an estimating of a position by use of a registered patch, according to one or more embodiments;

FIG. 4 illustrates a method of generating a patch, according to one or more embodiments;

FIG. 5 illustrates a method of estimating a position based on a patch tracking, according to one or more embodiments;

FIG. 6A illustrates three-dimensional (3D) point cloud data acquired by a position estimating apparatus, for example, and a previously registered patch, according to one or more embodiments;

FIG. 6B illustrates patch tracking through a general iterative closest point (ICP); and

FIG. 6C illustrates patch tracking through an edge-based ICP, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

FIG. illustrates an apparatus for estimating a position of a mobile robot, according to one or more embodiments.

A position estimating apparatus 100 includes a moving unit 110, a sensor unit 120, a range data acquisition unit 130, a control unit 140, and a storage unit 150, for example. Hereinafter, the following description will be made on the assumption that the position estimating apparatus 100 is a mobile robot, noting that alternative embodiments are equally available.

The moving unit 110 may include moving machinery such as a plurality of wheels for moving the mobile robot and a driving source for providing a driving force for the moving machinery.

The sensor unit 120 is mounted on the mobile robot 100 to sense the amount of movement of the mobile robot 100. To this end, the sensor unit 120 may include an encoder or a gyrosensor. The gyrosensor senses the rotation angle of the mobile robot, and the encoder enables a travelling path of the mobile robot 100 to be recognized. In detail, the moving distance and direction of the mobile robot 100 achieved by the encoder are integrated to estimate the current position and directional angle of the mobile robot 101 on a two-dimensional (2D) coordinate system. Conventionally, the encoder provides precise measurement for a short path, but the error of measurement accumulates with an increase of the path requiring calculation of integrals. Meanwhile, the sensor unit 120 may further include an infrared sensor, a laser sensor or an ultrasonic sensor for sensing obstacle related information used to build an obstacle map.

The range data acquisition unit 130 measures range data of a three-dimensional (3D) environment by processing scan data that is obtained by scanning a 3D environment. The range data acquisition unit 120 may include a sensor system using laser structured light for recognizing a 3D environment to sense and measure range data.

In an embodiment, the range data acquisition unit 130 includes a 3D range sensor to acquire 3D range information R[r, θ, ψ]. The range data acquisition unit 130 converts the 3D range information R[r, θ, ψ] to a 3D point cloud represented as P[x, y, z], where x is equal to r*cosψ*cosθ, y is equal to r* cosψ*sinθ, and z is equal to r*sinψ, for example.

The control unit 140 is configured to control an overall operation of the mobile robot, for example. The control unit 140 includes a path generating unit 142, a position estimating unit 144, and a path generating unit 146, for example.

The path generating unit 142 extracts at least one feature point from 3D point cloud data, generates a patch including points around the extracted feature point and stores the generated patch in the storage unit 150. In general, a feature point and a feature point descriptor are generated from an image obtained through an image sensor, by use of a feature point extracting algorithm such as a scale-invariant feature transform (SIFT), a maximally stable extremal region (MSER), or a Harris corner detector and used for position estimation. As an example, the patch including points around the feature point is used for position estimation. The patch may be provided in various 3D shapes. For example, the patch may be formed of points that are included in a regular hexahedron having a feature point of 3D cloud data as the center.

The patch generating unit 142 calculates normal vectors with respect to respective points of 3D point cloud data. The patch generating unit 142 converts the normal vector to an RGB image by setting 3D spatial coordinates (x, y, z), forming the normal vector, to individual RGB values. After that, the patch generating unit 142 converts the converted RGB image to a gray image, extracts corner points from the gray image by use of a corner extraction algorithm, and extracts a feature point from the extracted corner points. The feature point represents a point capable of specifying a predetermined shape, such as an edge or a corner of an object.

Since the patch generating unit 142 generates a patch using points existing around a feature point in a 3D space, the feature point may be a point positioned in the middle of the generated patch.

The patch generating unit 142 may store the patch together with position information of the feature point of the patch. In addition, the patch generating unit 142 may store the points forming the patch in the storage unit 140 to be divided into edge points forming an edge and normal points not forming an edge.

The position estimating unit 144 may estimate the position of the mobile robot 100 by use of a standard value corresponding to the starting position and directional angle from which it starts. The estimating of the position of the mobile robot 100 may represent estimating the position and directional angle of the mobile robot 100 in a 2D plane. The patch including a feature point existing on a map may serve as a standard in position of the mobile robot. Accordingly, position information of the mobile robot 100 may include the position and directional angle with respect to a feature point recognized by the mobile robot 100.

The position estimating unit 144 estimates and recognizes the position of the mobile robot 100 by use of comprehensive information including odometry information, angular velocity, and acceleration acquired by the moving unit 110 and the sensor unit 120. In addition, the position estimating unit 144 may perform position recognition at the same time of building up a map through a simultaneous localization and mapping (SLAM) by using the estimated position as an input. SLAM represents an algorithm which simultaneously performs localizing of a mobile robot and map building by repeating a process of building up a map of an environment of the mobile robot at a predetermined position and determining the next position of the mobile robot after travelling, based on the built up map.

As an example, the position estimating unit 144 may use a Kalman Filter to extract new range information integrated with encoder information and gyrosensor information. A Kalman Filter includes predicting, in which the position is estimated based on a model, and updating, in which the estimated value is corrected through a sensor value.

In the predicting, the position estimating unit 144 applies a preset model to a previously predicated value, thereby estimating an output for a given input.

In the predicting process, the position estimating unit 144 may predict the current position by use of previous position information and newly acquired information from the sensor unit 120. In the updating, the position estimating unit 144 may keep track of a plurality of patches from 3D point cloud data, which is newly obtained based on the predicted position, and may estimate a more accurate position by use of the tracked information. Previously stored patches each have a relative coordinate system and contain information used for conversion between a relative coordinate system and an absolute coordinate system. Accordingly, the position of the stored patch is converted to a relative position based on a coordinate system of the robot by use of the conversion information and predicted position information of the robot predicated during the above predicting process, and the difference between the relative position of the stored patch and the position of the tracked patch is calculated, thereby estimating the position of the robot.

In addition, the position estimating unit 114 may remove an erroneously estimated result among the tracked patches. To this end, the position estimating unit 114 may use random sample consensus (RANSAC) or a joint compatibility branch and bound (JCBB). Further, the position estimating unit 144 may be provided in various structures capable of performing position recognition and map building.

The position estimating unit 144 may track a patch as follows. The patch may include points around a feature point which is extracted from previously acquired 3D point cloud data. First, the position estimating unit 144 may calculate normal vectors with respect to respective points of the 3D point cloud data, and use the normal vectors to divide the respective points of the 3D point cloud data into edge points forming an edge and normal points not forming an edge. The position estimating unit 144 tracks the patch from the 3D point cloud data by use of an edge-based IPC-based algorithm in which the edge point of the patch is matched to the edge point of the 3D point cloud data and the normal point of the patch is matched to one of the edge point and the normal point of the 3D point cloud data without discriminating between the edge point and the normal point of the 3D point cloud data. The position estimating unit 114 matches the edge point of the patch to the closest edge point of the 3D point cloud data, and matches the normal point of the patch to the closest point of the 3D point cloud data.

The path generating unit 146 generates a path by use of position information of the mobile robot 100 that is recognized by the position estimating unit 144.

In an embodiment, the storage unit 150 may store operating systems, applications, and data that are needed for the operation of the position estimating apparatus 100. In addition, the storage unit 150 may include a patch storage unit 152 to store a plurality of patches each including points around a feature point, which is extracted from previously acquired 3D point cloud data.

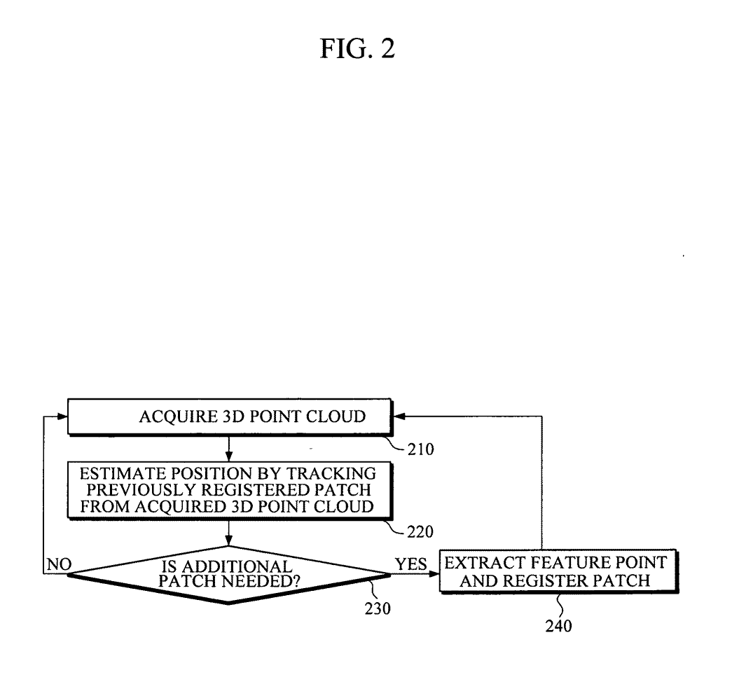

FIG. 2 illustrates a method of estimating a position of a mobile robot, according to one or more embodiments.

The position estimating apparatus 100 acquires 3D point cloud data (210).

The position estimating apparatus 100 estimates the position of the mobile robot 100 by tracking a plurality of patches from acquired 3D point cloud data. The plurality of patches each include points around a feature point which is extracted from previously acquired 3D point cloud data (220).

If it is determined that an additional patch is needed, for example, if the number of registered patches is below a preset number or the number of tracked patches is below a preset number (230), the position estimating apparatus 100 may register additional patches by extracting a feature point from the acquired 3D point data and generating a patch including points around the extracted feature point.

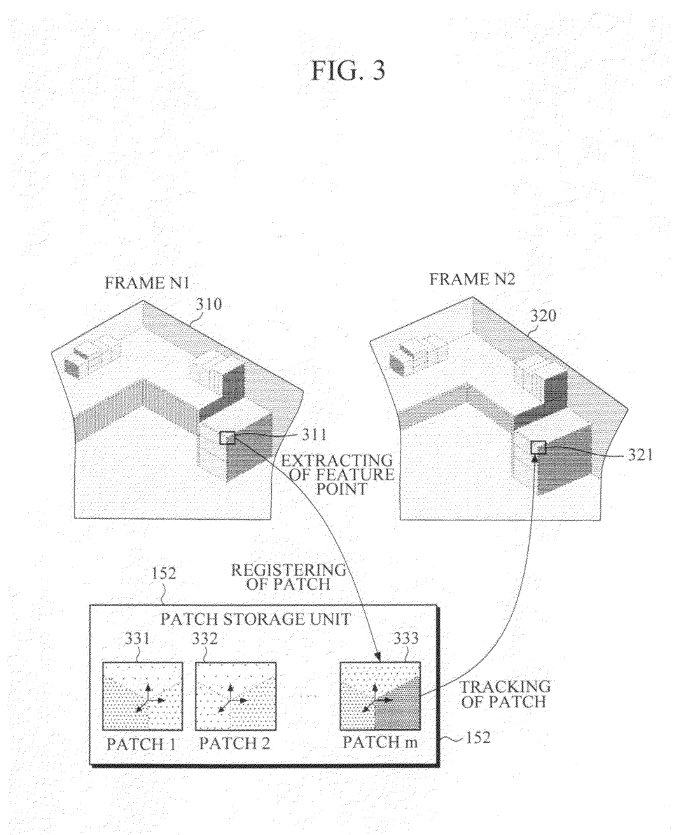

FIG. 3 illustrates an estimating of a position by use of a registered patch, according to one or more embodiments.

In FIG. 3, a frame N1 310 represents previously acquired 3D point cloud data, and a frame N2 320 represents newly acquired current 3D point cloud point data.

The position estimating apparatus 100 extracts a feature point from a region 311 of the frame N1 310, and stores a patch 333 including points around the extracted feature point in the patch storage unit 152. The patch storage unit 152 may store a plurality of patches 331, 332, and 333 including the patch 333 through registration.

If the position estimating apparatus 100 acquires the frame N2 320, the registered patches 331, 332, and 333 are tracked from the frame N2 320. For example, if the patch 333 is tracked from a region 321 of the frame N2 320, a relative position of the patch 333 on the frame N2 320 is identified. Accordingly, the position estimating apparatus 100 estimates an absolute position of the position estimating apparatus 100 by use of the relative position of the patch 333 identified on the frame N2 320.

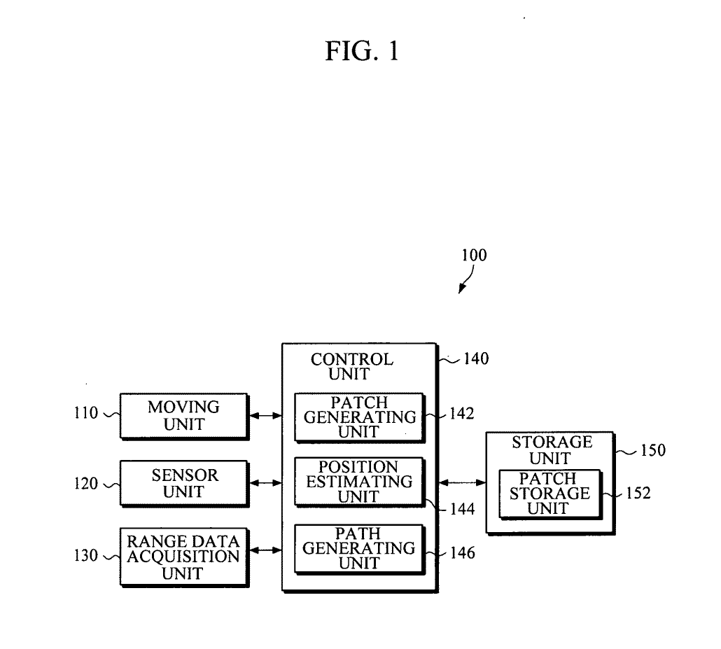

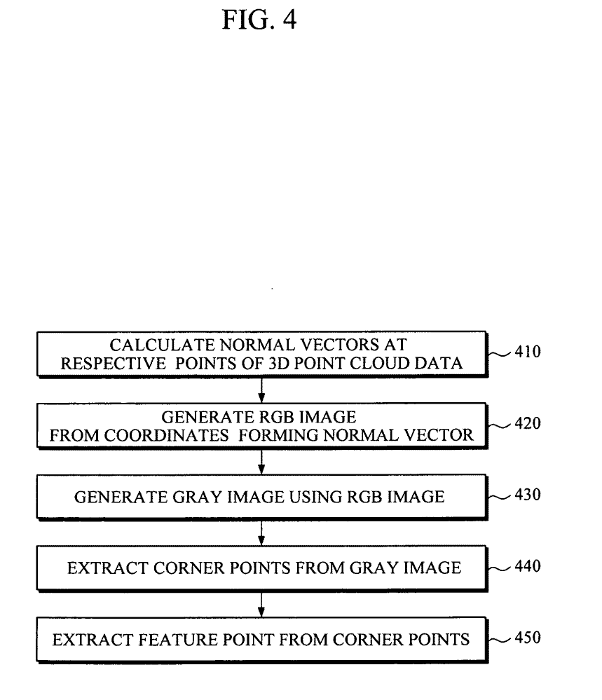

FIG. 4 illustrates a method of generating a patch, according to one or more embodiments. Though the path generating method will be described with reference to FIG. 4 in conjunction with FIG. 1, embodiments are not intended to be limited to the same.

The patch generating unit 142 calculates normal vectors with respect to respective points of previously acquired 3D point cloud data (410).

The patch generating unit 142 converts each normal vector to an RGB image by setting 3D spatial coordinates (x, y, z), forming the normal vector, to individual RGB values (420). Accordingly, R (Red), G (Green) and B (Blue) of the generated RGB image each represent respective directions of the normal vector on each point.

The patch generating unit 142 converts the converted RGB image to a gray image (430).

The patch generating unit 142 extracts corner points from the gray image by use of a corner extraction algorithm (440). Corner points may be extracted from the gray image through various methods such as the generally known Harris corner detection. Due to noise, a predetermined point may be erroneously extracted as an actual corner point. Accordingly, the patch generating unit 142 determines whether the extracted corner point is an eligible feature point, and extracts a corner point determined as a feature point (450). For example, the patch generating unit 142 may determine that the extracted corner point is not an eligible feature point if points around the extracted corner point have a gradient of normal vector below a predetermined level, or determine that the extracted corner point is an eligible feature point if points around the extracted corner point have a gradient of normal vector meeting a predetermined level.

Points around the extracted feature point are determined as a patch and stored in the storage unit 150. In this case, the patch may be stored together with position information about the extracted feature point. In addition, the patch is stored such that the points forming the patch are divided into edge points forming an edge and normal points not forming an edge. This reduces the calculation time required for performing an edge based ICP that is used to track a patch.

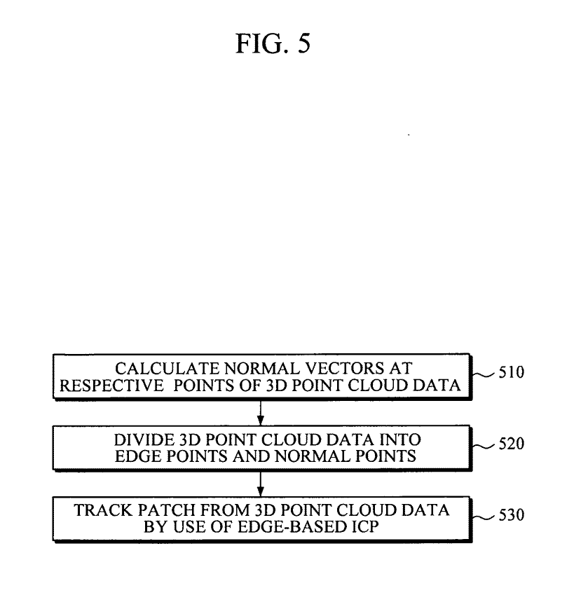

FIG. 5 illustrates a method of estimating the position based on patch tracking, according to one or more embodiments. Though the position estimating method will be described with reference to FIG. 5 in conjunction with FIG. 1, embodiments are not intended to be limited to the same.

The position estimating unit 144 calculates normal vectors at respective points of 3D point cloud data (510).

The position estimating unit 144 divides the respective points of the 3D point cloud data into edge points forming an edge or normal points not forming an edge by use of the normal vector (520). For example, points having a change in normal vector exceeding a predetermined level in a predetermined place are determined as edge points.

The position estimating unit 144 keeps tracking a patch from 3D point cloud data by use of an edge-based ICP. According to the edge-based ICP algorithm, the edge point of the patch is matched to the edge point of the 3D point cloud and the normal point of the patch is matched to one of the edge point and the normal point of the three dimensional 3D point cloud data without discriminating between the edge point and the normal point of the 3D point cloud data.

Accordingly, the position estimating unit 144 divides points forming the tracked patches into edge points and normal points and performs matching between the tracked patch and the 3D cloud data. Points forming the patch may be divided into edge points and normal points similar to the method of dividing the points of the 3D point cloud data into edge points and normal points. In addition, as described with reference to FIG. 4, if the patch is stored such that the points forming the corresponding patch are divided into edge points and normal points, a process of distinguishing the points forming the patch between edge points and normal points may be omitted in the position estimating, thereby reducing the time required for the position estimating.

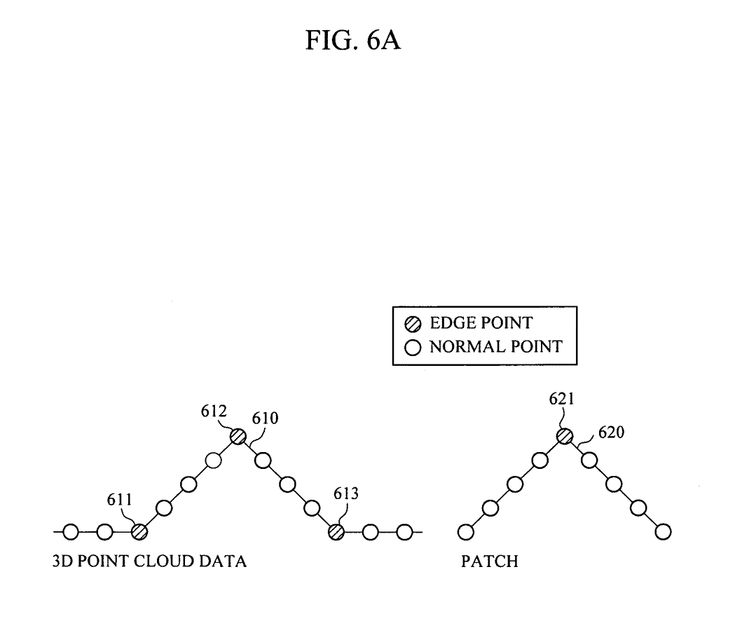

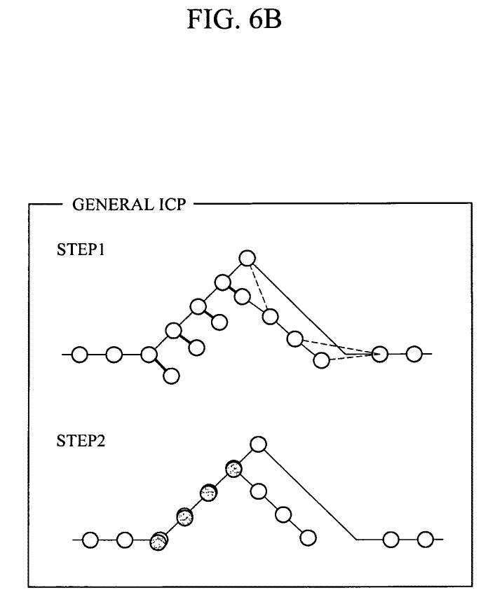

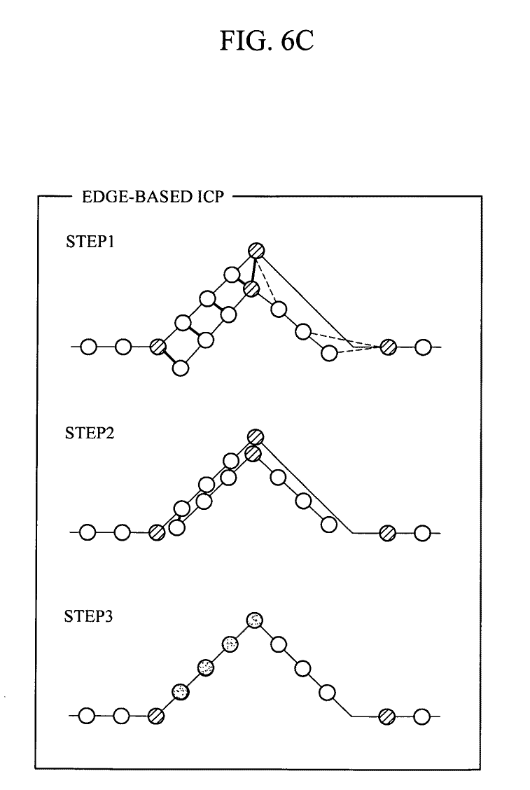

FIG. 6A illustrates an example of 3D point cloud data acquired by a position estimating apparatus and a previously registered patch, according to one or more embodiments.

In FIG. 6A, reference numeral 610 denotes 3D point cloud data schematically represented in a 2D form. Reference numeral 620 denotes a previously registered patch that is schematically represented in a 2D form. Points 611, 612, and 613 of the 3D point cloud data 610 represent edge points, and the remaining points represent normal points. A point 621 of the patch 620 represents an edge point and the remaining points represent normal points.

FIG. 6B illustrates a patch tracking by use of a general ICP.

According to a general ICP, matching between acquired 3D point cloud data and previously registered 3D point cloud data is performed without discriminating between a normal point and an edge point. Accordingly, as shown in step 1 of FIG. 6B, if a general ICP is applied to matching between 3D point cloud data and a patch, the matching is performed based on the closest point between the 3D point cloud data and the patch. This leads to erroneous matching shown in step 2 of FIG. 6B. Such erroneous matching may be caused by partial occlusion of the 3D point cloud data due to the direction of a camera.

FIG. 6C illustrates a patch tracking by use of an edge-based ICP, according to one or more embodiments.

According to the edge-based ICP, normal vectors are calculated at respective points of acquired 3D point cloud data and respective points forming a patch. The points forming the acquired 3D point cloud data and the points forming the patch are divided into edge points forming an edge and normal points not forming an edge by use of the normal vector. The position estimating unit 144 matches the edge point of the patch to the edge point of the 3D point cloud data and matches the normal point of the patch to one of the edge point and the normal point of the 3D point cloud data without discriminating between the edge point and the normal point of the 3D point cloud data.

Accordingly, as shown in step 1 of FIG. 6C, edge points are first matched to be closest, and in step 2, normal points are then matched to be closest. As a result, the edge points of the patch are matched to the edge points of the 3D point cloud data. As described above, the edge-based ICP algorithm provides a more accurate matching result than a general ICP algorithm. Accordingly, the amount of data calculation is reduced while maintaining the accuracy of the position estimating, thereby reducing the time required for the position estimating.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be a distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), which executes (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. An apparatus estimating a position of a mobile robot, the apparatus comprising:
a range data acquisition unit configured to acquire three-dimensional (3D) point cloud data;
a storage unit configured to store a plurality of patches, each stored patch including points around a feature point which is extracted from previously acquired 3D point cloud data; and
a position estimating unit configured to estimate the position of the mobile robot by tracking the plurality of stored patches from the acquired 3D point cloud data.

2. The apparatus of claim 1, further comprising
a patch generating unit configured to extract at least one feature point from the previously acquired 3D point cloud data, generate a patch including the at least one feature point and points around the extracted at least one feature point and store the generated patch in the storage unit as a stored patch.

3. The apparatus of claim 2, wherein the patch generating unit calculates normal vectors with respect to respective points of the previously acquired 3D point cloud data, converts the normal vector to an RGB image by setting 3D spatial coordinates (x, y, z) forming the normal vector to individual RGB values, converts the converted RGB image to a gray image, extracts corner points from the gray image by use of a corner extraction algorithm, extracts a feature point from the extracted corner points and generates the patch as including the extracted feature point and points around the extracted feature point.

4. The apparatus of claim 4, wherein the patch generating unit stores the generated patch together with position information of the extracted feature point of the generated patch.

5. The apparatus of claim 2, wherein the patch generating unit stores points forming the generated patch in the storage unit such that the points forming the patch are stored as divided points of edge points forming an edge and normal points not forming an edge.

6. The apparatus of claim 5, wherein the position estimating unit calculates normal vectors with respect to respective points of the 3D point cloud data, divides the respective points into edge points forming an edge and normal points not forming an edge by use of the normal vectors, and tracks the stored patch from the 3D point cloud data by use of an edge-based IPC-based algorithm in which the edge point of the stored patch is matched to the edge point of the 3D point cloud data and the normal point of the stored patch is matched to one of the edge point and the normal point of the 3D point cloud data without discriminating between the edge point and the normal point of the 3D point cloud data.

7. The apparatus of claim 6, wherein the position estimating unit matches the edge point of the stored patch to a closest edge point of the 3D point cloud data, and matches the normal point of the stored patch to a closest point of the 3D point cloud data.

8. A method of estimating a position of a mobile robot, the method comprising:
acquiring three-dimensional (3D) point cloud data; and
estimating the position of the mobile robot by tracking a plurality of stored patches from the acquired 3D point cloud data, the plurality of stored patches each including respective feature points and respective points around each respective feature point extracted from previously acquired 3D point cloud data.

9. The method of claim 8, further comprising generating a plurality of 3D point cloud patches, including:
extracting at least one feature point from the previously acquired 3D point cloud data;
generating a patch including points around the extracted at least one feature point; and
storing the generated patch as a stored patch.

10. The method of claim 9, wherein the generating of the plurality of 3D cloud patches comprises:
calculating normal vectors with respect to respective points of the previously acquired 3D point cloud data;
converting the normal vectors to an RGB image by setting 3D spatial coordinates (x, y, z) forming the normal vectors to individual RGB values;
converting the converted RGB image to a gray image, and extracting corner points from the gray image by use of a corner extraction algorithm; and extracting a feature point from the extracted corner points.

11. The method of claim 9, wherein, in the storing of the generated patch, the stored patch is stored together with position information of the feature point of the stored patch.

12. The method of claim 9, wherein, in the storing of the generated patch, points forming the stored patch are stored as divided points of edge points forming an edge and normal points not forming an edge.

13. The method of claim 12, wherein the estimating of the position comprises:
calculating normal vectors with respect to respective points of the 3D point cloud data;
dividing the respective points into edge points forming an edge and normal points not forming an edge by use of the normal vectors; and
tracking the stored patch from the 3D point cloud data by use of an edge-based IPC-based algorithm in which the edge point of the stored patch is matched to the edge point of the 3D point cloud data and the normal point of the stored patch is matched to one of the edge point and the normal point of the 3D point cloud data without discriminating between the edge point and the normal point of the 3D point cloud data.

14. The method of claim 13, wherein the tracking of the stored patch comprises:
matching the edge point of the stored patch to a closest edge point of the 3D point cloud data; and
matching the normal point of the stored patch to a closest point of the 3D point cloud data.
